(19) United States
(12) Patent Application Publication
(10) Pub. No.: US 2007/0098927 A1
(43) Pub. Date: May 3, 2007

(54) Ink compositions and methods for controlling color on a print medium

(76) Inventors: Linda C. Uhlir-Tsang, Corvallis, OR (US); Mary E. Austin, Corvallis, OR (US); Hiang P. Lauw, Corvallis, OR (US); Joseph W. Tsang, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,345

(22) Filed: Oct. 28, 2005

(51) Int. Cl. C09D 11/00; B41M 5/00

(52) U.S. Cl. 428/32.1; 106/31.27; 106/31.6; 106/31.43; 106/31.75; 106/31.47; 106/31.49; 106/31.77; 106/31.78

(57) ABSTRACT

The present invention relates to ink compositions including ink additives for controlling the color of the ink composition to provide media independence, improve black dye neutrality, and improve individual dye selection for a dye set, methods for producing the ink compositions, and methods using the ink compositions having the ink additives are disclosed.

### TECHNICAL FIELD

The present invention relates generally to ink-jet printing, and more particularly, to ink additives for ink-jet inks used to control color and methods of controlling the color with the ink additives and obtaining media independence across plain and specialty media.

### BACKGROUND OF THE INVENTION

Ink-jet printing is a printing process where droplets of ink are deposited on a print medium to form alphanumeric characters, area-fills, images, and other patterns. The ink must be able to provide printed images having good color characteristics, such as the correct hue and high chroma.

While the formation of colors on plain paper is required for inks, the inks should also be able to be used on other print media or conditions such as specialty media, including transparency film, coated paper, and photo paper. While effective printing on some of these media may be met by suitable ink vehicle design, other print conditions must be met by the proper selection and combination of the colorants used in the inks. The selection of the colorants becomes even more important when additional limitations are placed on the choice of the colorants because of printing system requirements such as good permanence or other factors.

In many cases, the color performance cannot be resolved by changing color maps of the inks because some of the primary colorants that are used for the inks are not true. Further, some inks may never be able to attain some desired secondary or tertiary colors. The problem may be made worse on some media types, such as photographic media.

The media can, in some instances, be changed to accommodate the ink in order to meet the color requirements, but this may result in detrimental changes to other aspects of performance. Thus, a need exists for ink-jet inks that have better color rendition.

In addition, a color ink set typically requires at least three to four different colorants, the fourth typically consisting of black. Some of these colorants may have suitable performance parameters, but an additional colorant with suitable color to match the preexisting colorants may not have as good a performance. In that situation, a different colorant with suitable performance but unsuitable color may have its color adjusted in order to optimize the color gamut of the ink set.

### SUMMARY OF THE INVENTION

In one embodiment, an ink composition includes an ink vehicle, a colorant and means for controlling color produced by the colorant on a print medium.

In another embodiment, a process for forming an ink composition includes selecting an ink additive for its ability to control color of a colorant. The process also includes admixing an ink vehicle with the colorant and the ink additive, thus, producing the ink composition.

In yet a further embodiment, a method for controlling color of an ink composition printed on a print medium includes selecting an ink additive for its ability to control color of a colorant and admixing the selected ink additive, the colorant, and the ink vehicle, thus, producing the ink composition. The method further includes placing the ink composition on a print medium.

In an additional embodiment, an ink-jet printing system includes a print medium and an ink composition configured for printing on the print medium. The ink composition includes an ink vehicle, a colorant admixed in the ink vehicle, and an ink additive for controlling the color produced by the colorant on a print medium.

### BRIEF DESCRIPTION OF THE DRAWINGS

While the specification concludes with claims particularly pointing out and distinctly claiming that which is regarded as the present invention, the advantages of the invention may be more readily ascertained from the following description of the invention when read in conjunction with the accompanying drawings in which:

FIGS. 1-11, 14, 19, and 25 are graphs showing the color change of particular embodiments of ink compositions of the present invention;

FIGS. 12, 13, 15-18, and 20-23 are graphs of color changes of two embodiments of ink compositions of the present invention on different media; and

FIG. 24 illustrates a graph of color changes of various embodiments of ink compositions and conductivities of the ink compositions of the present invention.

### DETAILED DESCRIPTION OF THE INVENTION

In each of the various embodiments, the present invention is directed towards ink additives and methods for controlling the color of an ink composition on a print medium using the ink additive. Without being bound to any particular theory, it is understood that in at least one embodiment of an ink additive described herein, upon being printed on a print medium in an ink composition having a colorant, the ink additive changes how the colorant interacts with the print medium and, thus, changes the visible color of the colorant.

As used herein, “liquid vehicle” or “ink vehicle” will refer to the fluid in which colorants, latex particles, colloids, and/or other ink-jet ink constituents are dispersed to form ink-jet inks. Suitable liquid vehicles and ink vehicle components include, but are not limited to, a variety of different agents, such as surfactants, co-solvents, buffers, biocides, sequestering agents, humectants, viscosity modifiers, water and any combination thereof. Other compounds that may serve as or be employed in the ink vehicle include, but are not limited to, organic solvents, surface-active agents, metal chelators, and any combinations thereof. As will be apparent to one of skill in the art, the relative amounts of ink vehicle and the various constituents described herein may be varied to accommodate the specific pen architecture of the ink-jet printer.

In one embodiment, water may make up a substantially large percentage of the overall ink vehicle or ink composition of the present invention. For instance, the water may comprise purified or deionized water in an amount of from about 5 to about 95 percent by weight of the ink composition.

In another embodiment, a solvent or co-solvent may be included in the ink composition. Classes of co-solvents that may be used include aliphatic alcohols, aromatic alcohols, diols, glycol ethers, polyglycol ethers, formamides, acetamides, long chain alcohols and any combinations thereof. Examples of such solvents or co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs of polyethylene glycol alkyl ethers, both substituted and unsubstituted formamides, both substituted and unsubstituted acetamides, trimethylolpropane, 2-pyrrolidinone, 1,5-pentanediol, and any combination thereof.

In a further embodiment, an effective amount of a surfactant component of the ink composition may be achieved using a single surfactant ingredient or a mixture of surfactants. Generally, the surfactants may be used to increase the dispersion stability of the colorants and/or the latex particle, and to increase the penetration of the ink composition into the print medium. A wide array of surfactant classes may be used, including, but not limited to, cationic, anionic, zwitterionic or non-ionic surfactants. Non-limiting examples of surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, Rhodafac, sodium dodecylsulfate, Triton N and X-series, and any combinations thereof.

In another embodiment, the ink composition may include a biocide, fungicide or other antimicrobial agent capable of inhibiting the growth of microorganisms. Non-limiting examples of biocides that may be used include without limitation: NUOSEPT 95, available from Hals America (Piscataway, N.J.); PROXEL GXL, available from Arch Chemicals (Wilmington, Del.), glutaraldehyde, available from Union Carbide Company (Bound Brook, N.J.) under the trade designation UCARCIDE 250, and Vancide, available from R.T. Vanderbilt Co. and any combinations thereof.

In yet another embodiment, the ink composition may include a buffer agent. The buffer agents in the ink composition may be used to modulate pH. The buffer agent may be an organic-based biological buffer or an inorganic buffer. Non-limiting examples of buffers that may be used include Trizma base, available from Aldrich Chemical (Milwaukee, Wis.), 4-morpholineethanesulfonic acid (MES), 4-morpholinepropane sulfonic acid (MOPS), and any combinations thereof.

In another embodiment, the ink composition may include sequestering agents. One example of a sequestering agent is a metal chelating agent present in the ink composition. Metal chelating agents may be used to bind transition metal cations that may be present in the ink composition. Non-limiting examples of metal-chelating agents include ethylenediaminetetraacetic acid (EDTA), diethylenetriaminepentaacetic acid (DTPA), trans-1,2-diaminocyclohexanetetraacetic acid (CDTA), (ethylenedioxy)diethylenedinitrilotetraacetic acid (EGTA), other chelators that bind transition metal cations, and any combinations thereof.

As used herein, “effective amount” refers to the minimal amount of or concentration of a substance or agent, which is sufficient to achieve a desired effect. Amounts, concentrations, and other numerical data may be expressed or presented herein in a range format. It is to be understood that such a range format is used for convenience and, thus, should be interpreted in a flexible manner to include not only numerical values associated with the limits of the range, but also to include all the individual numerical values or sub-ranges encompassed within that range as if each numerical value and sub-range is explicitly stated.

In one embodiment, an ink composition comprises effective amounts of an ink vehicle, a colorant admixed in the ink vehicle, and an ink additive for controlling the color produced by the colorant. In various embodiments, the ink additives may be present in the ink composition in a range of from about 0.1% to about 10% by weight of the ink composition.

An example of an ink additive used for controlling the color produced by the colorant of the ink composition includes, but is not limited to: amines, including aliphatic, aromatic, primary, secondary, tertiary, and amine oxides; a proton sponge (1,8-bis-[dimethylamino]naphthalene); triethanolamine; diethanolamine; trizma buffer; 2,6-dimethylaminopyridine (DMAP); 3-pyridylcarbinol; N-methyl-1,3-propanediamine; EDTA; piperidine; piperazine; pyridine-N-oxide; 1-methyl-2-thioimidazole; imidazo[1,2-a]pyridine; N,N-diethylethylenediamine; glycine; DL-threonine; imidazole; MOPS buffer; 6-amino-1-naphthol-3-sulfonic acid; 6-amino-4-hydroxy-2-naphthalene-sulfonic acid; Dequest 2054; piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine (DABCO); isonicotinic acid; piperazine-1,4-bis(2-ethanesulfonic acid); compounds that are organic or inorganic salts in the ink composition and/or can form salts when deposited on the medium on which the ink composition is printed including: triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; succinic acid; butyric acid; sodium methanesulfonate; sodium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

Other ink additives that may be used include compounds that can form salts and/or amines in the ink composition, such as, for example, caprolactam (i.e., by ring opening), urea and its derivatives (i.e., by decomposition) and any combination thereof.

It will be apparent to those of ordinary skill in the art that the type and amount of ink additive used for controlling the color of the ink composition may be varied and determined using routine experimentation in order to achieve or control a desired color. For instance, different ink additives may be selected for different colorants. Further, simple experimentation with a given colorant, ink additive and print medium may be used to determine the appropriate ink additive and concentration of the ink additive to be placed in the ink composition. In one embodiment, the ink additive is selected by placing a first ink composition without the ink additive on the print medium, placing a second ink composition with the ink additive on the print medium, and comparing a color of the first ink composition to a color of the second ink composition.

In another embodiment, the ink composition including the ink vehicle, the colorant, and the ink additive for controlling the color produced by the colorant is applied to or printed on a print medium using an ink-jet printer. The print media may include, without limitation, HP Premium Glossy Photo Paper (HPPGPP), Hewlett Packard Plain Paper (HPPP), and porous media such as Epson Premium Glossy Photo Paper (EPGPP) and HP experimental medium 1.

In another embodiment, the colorant of the ink composition is dye-based. Non-limiting examples of colorants that may be used include Fast Black 2, DB199Na, Projet cyan 485, a mixture of RR23 and AR52, Y104, M700, Projet K820, Projet K287, DJR814, K-1334, and any combination thereof. Other dyes that may be used as the colorant include without limitation water-soluble dyes such as sulfonate and carboxylate dyes. Non-limiting examples include Sulforhodamine B, Acid Blue 113, Acid Blue 29, Acid Red 4, Rose Bengal, Acid Yellow 17, Acid Yellow 29, Acid Yellow 42, Acridine Yellow G, Nitro Blue Tetrazolium Chloride Monohydrate or Nitro BT, Rhodamine 6G, Rhodamine 123, Rhodamine B, Rhodamine β cyanate, Safranine 0, Azure B, Azure B Eosinate, Basic Blue 47, Basic Blue 66, Thioflacin T, Auramine 0, Direct Yellow 132, Direct Blue 199, Magenta 377, Acid Red 52 (AR52), and any combination thereof. Additional dyes that may be used include water-insoluble dyes, such as azo, xanthene, methane, polymethine, and anthroquinone dyes.

In yet a further embodiment of the present invention, an ink-jet printing system may include a print medium and an ink composition configured for printing on the print medium. The ink composition may include a liquid vehicle, a colorant, and an ink additive for controlling color.

In another embodiment, a method for controlling the color of a colorant of an ink composition printed on a print medium includes jetting the ink composition onto the print medium. The ink composition may include a liquid vehicle, a colorant, and an ink additive for controlling color.

### EXAMPLES

The following examples describe various embodiments of ink compositions and methods for printing the ink compositions on a medium with a pen of an ink jet printer in accordance with the present invention. The examples are merely illustrative and are not meant to limit the scope of the present invention in any way. The following examples, except where otherwise noted, use an ink vehicle including approximately 10% DEG, 1.5% Triton X-100, and 0.2% Trizma base. In the examples, the pH is between about 8 to about 8.5.

### Example I

Varying amounts of an ink additive for controlling color of a colorant are admixed in an ink vehicle having a colorant, such as Projet cyan 485 dye. In the exemplary embodiment, the ink additive is sodium acetate. The ink composition is printed on a porous print medium such as an experimental medium. The hue angle data of a 150% area fill block for the printed ink as a function of sodium acetate concentration is determined. The results are shown in Table 1 which indicates the color change in relation to the ink additive concentration.

TABLE 1
Example of maximum hue angle as a function of
sodium acetate concentration of an ink containing Projet cyan
485 dye on experimental porous medium 3.

| Sodium acetate | |
|---|---|
| concentration | Hue angle at |
| (wt %) | 150% area fill |
| 0.5 | 221 |
| 2.5 | 237 |
| 5.5 | 247 |

As illustrate in Table 1, the hue angle increases with an increasing amount of ink additive. Thus, the increased ink additive concentration is able to control the color of the colorant.

### Example II

An ink composition including an ink additive for controlling color of a colorant is prepared in an ink vehicle having a colorant such as DB199 dye. In this exemplary embodiment, the ink additive is 4,5-dihydroxy-1,3-benzenedisulfonic acid. The ink composition including the ink additive, or control ink composition having no additive, is printed on a swellable medium such as HPPGPP and a plain paper medium such as HPPP.

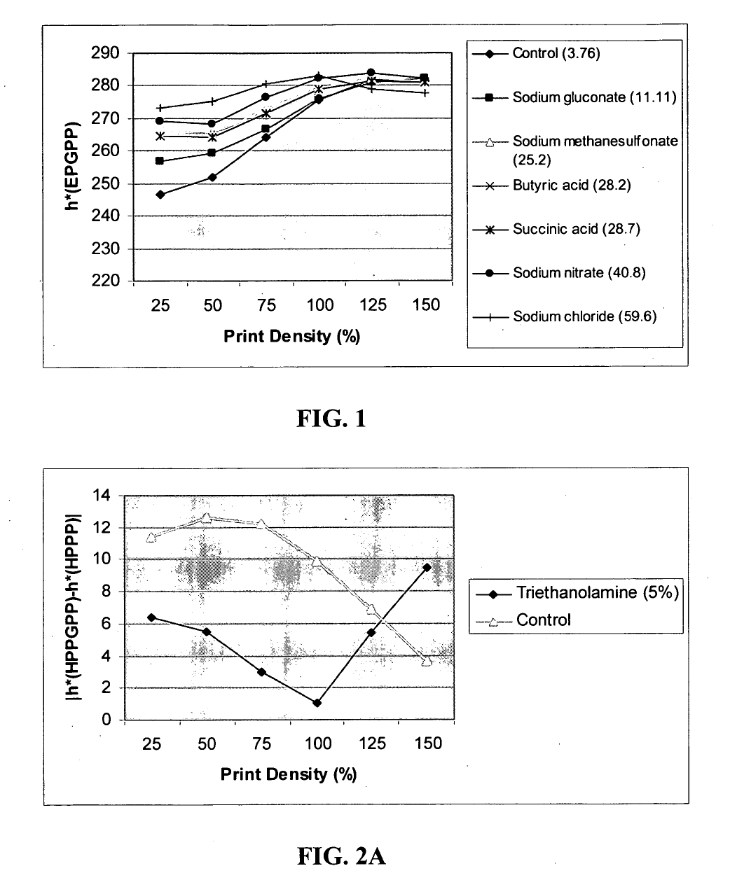

As known by those of ordinary skill in the art, the CIE L*a*b* system is used to measure or specify the chromaticity (c*, square root of the sum of a*2 and b*2) or the properties of hue [arc tan(b*/a*)] and saturation (c*/L*) on a two-dimensional chromaticity diagram. The a* measures redness-greenness on the x-axis, or the horizontal axis, and b* measures yellowness-blueness on the y-axis, or the vertical axis. The L* measures lightness-darkness on the z-axis. To assess the chromaticity of the ink compositions and the ability of the ink additives of the present invention to control the color of the colorant, the ink compositions were printed on media and the chromaticity was assessed using the CIE L*a*b* system. FIG. 1 illustrates hue angle vs. print density.

### Example III

In another embodiment, an ink composition including an ink additive for controlling the color of a colorant is prepared in an ink vehicle having a colorant, such as an experimental non-metallized black dye. In this embodiment, the ink additive is triethanolamine. The ink compositions having varying amounts of triethanolamine are printed on a swellable medium.

In another embodiment, the black dye may comprise a metallized black dye, wherein the black dye is present in an amount from about 3-5% of the total ink composition. The ink composition of this embodiment further includes the ink vehicle in an amount of about 8% 2-pyrrolidone and about 8% 1-(2-hydroxyethyl)-2-pyrrolidone. The ink composition may further include a buffer agent to maintain a pH of the ink composition at about 8 and a biocide, wherein the ink additive is present in amount of about 2.5%. In other embodiments, the ink additive may be triethanolamine, 3-pyridylcarbinol, urea, or any combination thereof, wherein the ink composition can exhibit a color shift that is redder in the respective order of ink additives.

### Example IV

In another embodiment, an ink composition includes an ink additive for controlling color of a colorant that is present in the ink composition in an amount of from about 2.5% to about 5%, an ink vehicle including about 10% diethylene glycol, a dye, and about 1.5% of a surfactant, such as Triton X-100.

In one example of this embodiment, the dye may be Projet Cyan 485 and when the ink composition is for use on a porous medium, the ink additive may comprise: sodium octanoate; sodium acetate at a concentration of from about 0.5% to about 5.5%, which becomes bluer at increasing concentrations; sodium dihydrogen phosphate; triethylamine; cyanoacetic acid; MOPS buffer; Dequest 2054 at a concentration of about 3% or 6% which becomes bluer at increasing concentrations; or any combinations thereof. When the ink composition is for use on a swellable medium, the ink additive may comprise: triethanolamine; sodium acetate at a concentration of from about 0.5% to about 5.5%, which becomes bluer at increasing concentrations; sodium dihydrogen phosphate; and any combinations thereof.

In another example of this embodiment, the dye of the ink composition may be a yellow dye, such as Y104, and the ink additive of the ink composition may be triethanolamine. In this example, the ink composition is suitable for use on a swellable or porous medium.

In a further example of this embodiment, the dye of the ink composition may be a black dye, such as K287, and the ink additive of the ink composition may be 3-pyridylcarbinol. In this example, the ink composition is suitable for use on a swellable or porous medium.

In yet an additional example of this embodiment, the dye of the ink composition is a magenta dye, such as AR52, and the ink additive of the ink composition may be triethanolamine. In this example, the ink composition is suitable for use on a swellable or porous medium.

### Example V

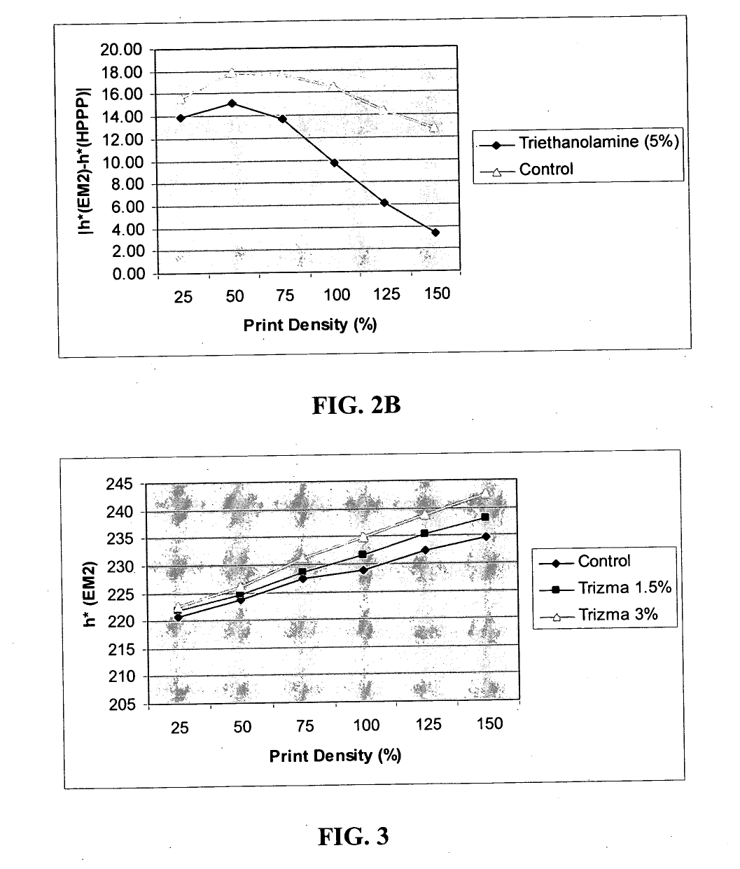

In another embodiment, an ink composition including an ink additive for controlling color of a colorant is prepared in an ink vehicle having a cyan colorant such as Projet Cyan 485. In this embodiment, the ink additive is triethanolamine. The ink composition having 5% triethanolamine is printed on a swellable medium such as HPPGPP and on a plain paper such as HPPP. A curve representing hue shift for the ink composition is shown in FIG. 2A.

The ink composition having 5% triethanolamine is also printed on porous media such as experimental porous medium 2 and HPPP. A curve representing a hue shift for the ink composition is shown in FIG. 2B. FIGS. 2A and 2B illustrate that the addition of the ink additive, triethanolamine, to the ink composition and placement of the ink composition on a swellable and porous medium, respectively, approaches the color of the ink composition printed on plain paper. Thus, the ink additive is able to control the color of the colorant when it is printed on a different medium.

### Example VI

In an additional embodiment, an ink composition including an ink additive for controlling color of a colorant is prepared in an ink vehicle having a cyan colorant such as Projet Cyan 485. In this embodiment, the ink additive is trizma. The ink composition having varying concentrations of the ink additive is printed on porous media such as Hartman, wherein a curve representing the hue shift for the ink compositions with the varying compositions of ink additive is shown in FIG. 3. FIG. 3 illustrates how the color of the cyan copper phthalocyanine (e.g., Projet cyan 485) is controlled by the ink additive of the ink composition printed on the print medium.

### Example VII

In yet another embodiment, three ink compositions including three different ink additives for controlling color of a colorant are prepared in an ink vehicle having a black colorant such as an experimental black dye. In this embodiment, the ink additives are urea, triethanolamine, and 3-pyridylcarbinol. The ink compositions having the three different ink additives are printed on plain paper.

### Example VIII

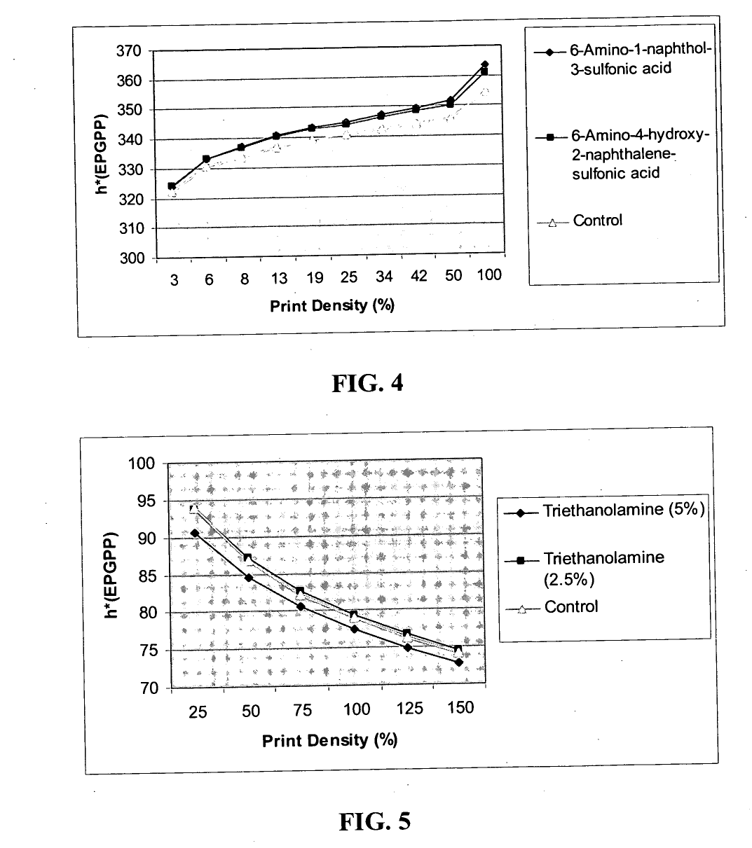

In an additional embodiment, an ink composition including an ink additive for controlling color of a colorant is prepared in an ink vehicle having a magenta colorant, such as the metallized magenta dye DJR814. In this embodiment, the ink additive is 6-amino-1-napthol-3-sulfonic acid or 6-amino-4-hydroxy-2-naphthalene-sulfonic acid. Ink compositions having the two different ink additives are printed on porous paper (e.g., Epson Premium Glossy Photo Paper). Curves representing the hue shift for the ink compositions are shown in FIG. 4.

### Example IX

In yet another embodiment, an ink composition including an ink additive for controlling color of a colorant is prepared in an ink vehicle having a yellow colorant, such as the non-metallized yellow dye Y104. In this embodiment, the ink additive is triethanolamine present in concentrations of 0%, 2.5% or 5%. Ink compositions having the varying concentrations of triethanolamine and the control are printed on a swellable medium (e.g., HPPGPP), wherein curves representing the hue shift values for the ink compositions are shown in FIG. 5.

### Example X

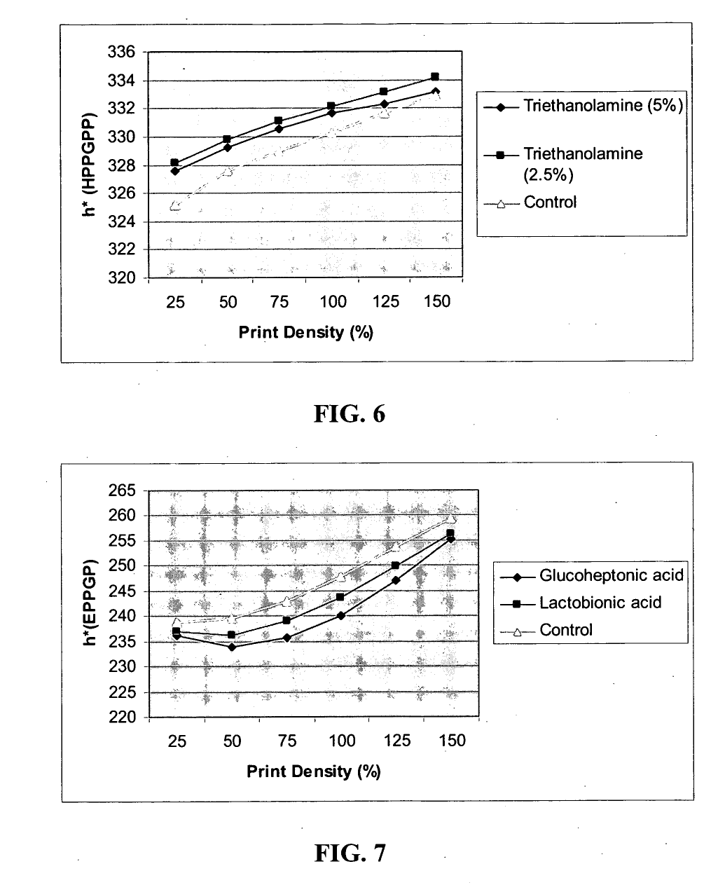

In still a further embodiment, an ink composition includes an ink additive for controlling color of a colorant is prepared in an ink vehicle having a magenta colorant such as the non-metallized magenta dye AR52. The ink additive is triethanolamine present in concentrations of 0%, 2.5% or 5%. Ink compositions having the varying concentrations of triethanolamine and the control are printed on a swellable medium (e.g., HPPGPP), to obtain curves representing the hue shift values for the ink compositions are shown in FIG. 6.

### Example XI

In yet an additional embodiment, an ink composition includes an ink additive for controlling color of a colorant present in an amount of about 10%, a colorant (such as, for example, a dye) and about 1.5% Tergitol 15-S-12. In this embodiment, the dye may be Projet Cyan 854 and the ink additive may be 3-pyridylcarbinol, diethanolamine or triethanolamine. The ink compositions are suitable for use on a porous medium.

### Example XII

In yet another embodiment, an ink composition including an ink additive for controlling color of a colorant is prepared in an ink vehicle having a colorant such as a black dye (e.g., Projet K820). The ink vehicle includes about 10% DEG, 1.5% Triton X-100, and about 0.2% Trizma, and the pH of the ink composition is adjusted to between about 8 and about 8.5. In this embodiment, the ink additive is glucoheptonic or lactobionic present in a concentration of about 5%. Ink compositions having the two ink additives and a control are printed on a medium (e.g., EPGPP). Curves representing the hue shift values for the ink compositions are shown in FIG. 7.

### Example XIII

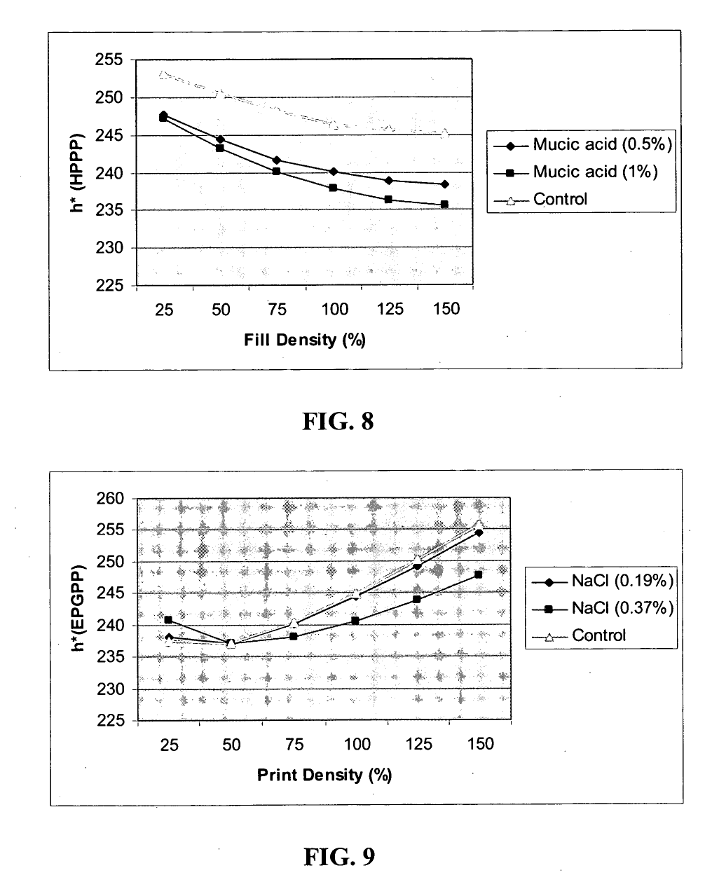

In an additional embodiment, an ink composition including an ink additive for controlling color of a colorant is prepared in an ink vehicle having a colorant such as a black dye (e.g., Projet K820). The ink vehicle includes about 10% DEG, 1.5% Triton X-100, and about 0.2% Trizma, and the pH of the ink composition is adjusted to between about 8 and about 8.5. In this embodiment, the ink additive is mucic acid present in two concentrations of about 1% and about 0.1%. Ink compositions having the two concentrations of mucic acid and a control are printed on a medium (e.g., HPPP), wherein curves representing the hue shift values for the ink compositions are shown in FIG. 8. In this embodiment, the color changes may also occur on plain paper, and the black colorant may become redder which may be desirable.

### Example XIV

In yet an additional embodiment, an ink composition including an ink additive for controlling color of a colorant is prepared in an ink vehicle having a colorant such as a black dye (e.g., Projet K820). The ink vehicle includes about 10% DEG, 1.5% Triton X-100, and about 0.2% Trizma, and the pH of the ink composition is adjusted to between about 8 and about 8.5. In this embodiment, the ink additive is sodium chloride present in two concentrations of about 0.187% and about 0.373%. Ink compositions having the two concentrations of NaCl and a control were printed on a medium (e.g., EPGPP). Curves representing the hue shift values for the ink compositions are shown in FIG. 9.

### Example XV

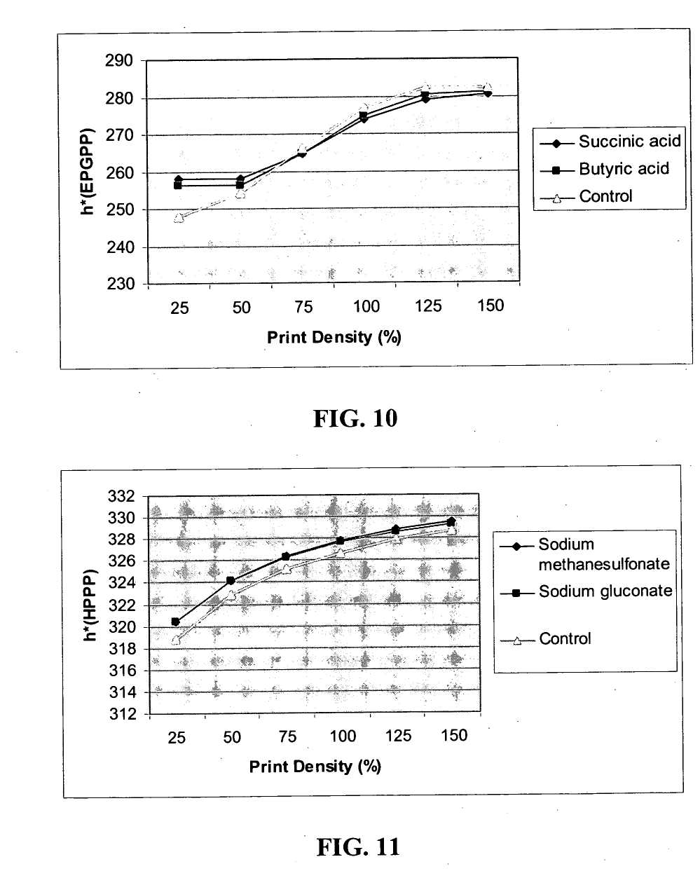

In yet an additional embodiment, an ink composition including an ink additive for controlling color of a colorant is prepared in an ink vehicle having a colorant such as a black dye (e.g., K1334). The ink vehicle includes about 10% DEG, about 1.5% Triton X-100, and about 0.2% Trizma, and the pH of the ink composition is adjusted to between about 8 and about 8.5. In this embodiment, the ink additive is succinic acid or butyric acid present in a concentration of about 5%. Two ink compositions each having one of the two additives and a control composition are printed on a medium (e.g., EPGPP). Curves representing the hue shift values for the ink compositions are shown in FIG. 10.

### Example XVI

In a further embodiment, an ink composition including an ink additive for controlling color of a colorant is prepared in an ink vehicle having a colorant such as a magenta dye (e.g., AR52). The ink vehicle includes about 10% DEG, about 1.5% Triton X-100, and about 0.2% Trizma, and the pH of the ink composition is adjusted to between about 8 and about 8.5. In this embodiment, the ink additive is sodium methanesulfonate or sodium gluconate present in a concentration of about 5%. Two ink compositions each having one of the two additives and a control composition are printed on a medium (e.g., HPPGPP). Curves representing the hue shift values for the ink compositions are shown in FIG. 11.

### Example XVII

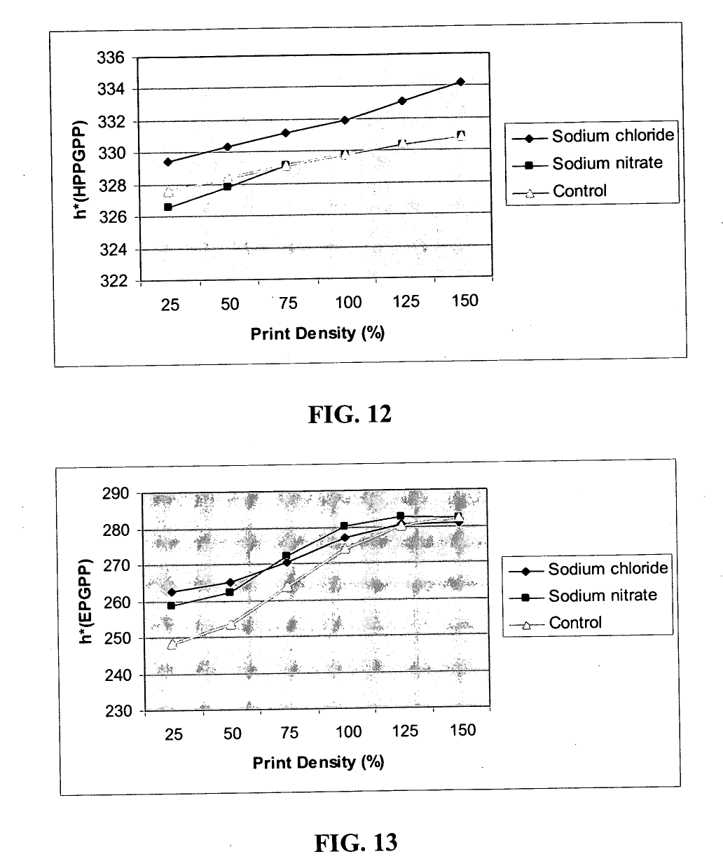

In a further embodiment, an ink composition including an ink additive for controlling color of a colorant is prepared in an ink vehicle having a colorant such as a magenta dye (e.g., AR52). The ink vehicle includes about 10% DEG, about 1.5% Triton X-100, and about 0.2% Trizma, and the pH of the ink composition is adjusted to between about 8 and about 8.5. In this embodiment, the ink additive is sodium chloride or sodium nitrate present in a concentration of about 5%. Two ink compositions each having one of the two additives and a control are printed on a medium (e.g., HPPGPP). Curves representing the hue shift values for the ink compositions are shown in FIG. 12.

### Example XVIII

In still another embodiment, an ink composition including an ink additive for controlling color of a colorant is prepared in an ink vehicle having a colorant such as a black dye (e.g., K1334). The ink vehicle includes about 10% DEG, about 1.5% Triton X-100, and about 0.2% Trizma, and the pH of the ink composition is adjusted to between about 8 and about 8.5. In this embodiment, the ink additive is sodium chloride or sodium nitrate present in a concentration of about 5%. Two ink compositions each having one of the two additives and a control are printed on a medium (e.g., EPGPP), wherein curves representing the hue shift values for the ink compositions are shown in FIG. 13.

### Example XIX

In still another embodiment, an ink composition including an ink additive for controlling color of a colorant is prepared in an ink vehicle having a colorant such as K1334, a black dye. The ink vehicle includes about 10% DEG, about 1.5% Triton X-100, and about 0.2% Trizma, and the pH of the ink composition is adjusted to between about 8 and about 8.5. In this embodiment, the ink additive is succinic acid or butyric acid present in a concentration of about 5%. Two ink compositions each having one of the two additives and a control are printed on a medium (e.g., EPGPP).

### Example XX

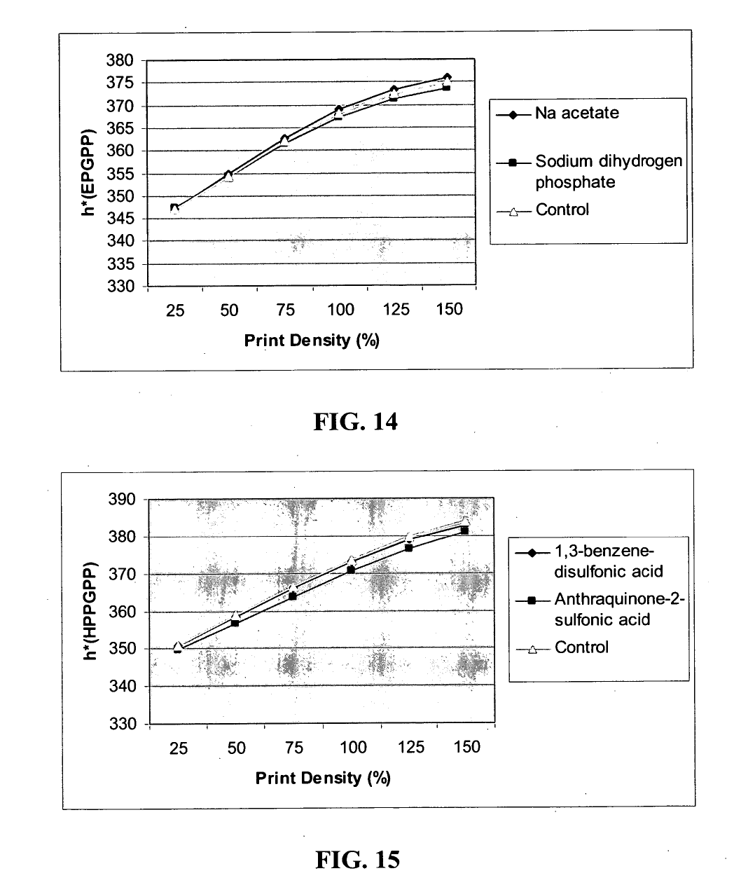

In another embodiment, an ink composition including an ink additive for controlling color of a colorant is prepared in an ink vehicle having a colorant such as a magenta dye (e.g., M377). The ink vehicle includes about 10% DEG, about 1.5% Triton X-100, and about 0.2% Trizma, and the pH of the ink composition is adjusted to between about 8 and about 8.5. In this embodiment, the ink additive is sodium acetate or sodium dihydrogen phosphate present in a concentration of about 5%. Two ink compositions each having one of the two additives and a control are printed on a medium (e.g., EPGPP). Curves representing the hue shift values for the ink compositions are shown in FIG. 14.

### Example XXI

In another embodiment, an ink composition including an ink additive for controlling color of a colorant is prepared in an ink vehicle having a colorant such as a magenta dye (e.g., M377). The ink vehicle includes about 10% DEG, about 1.5% Triton X-100, and about 0.2% Trizma, and the pH of the ink composition is adjusted to between about 8 and about 8.5. In this embodiment, the ink additive is 1,3-benzene-disulfonic acid or anthraquinone-2-sulfonic acid present in a concentration of about 5%. Two ink compositions each having one of the two additives and a control are printed on a medium (e.g., HPPGPP). Curves representing the hue shift values for the ink compositions are shown in FIG. 15.

### Example XXII

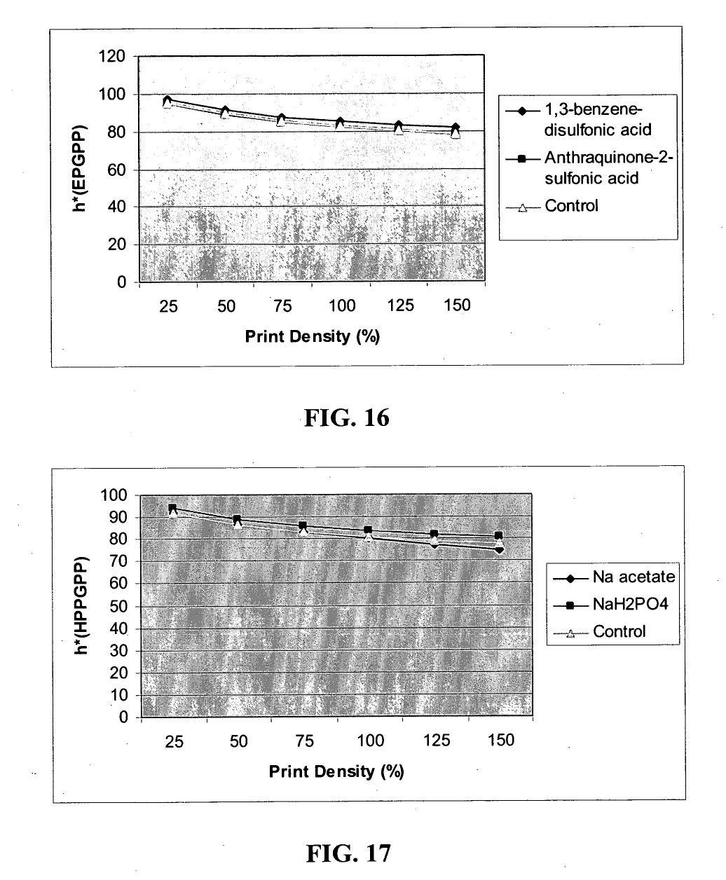

In another embodiment, an ink composition including an ink additive for controlling color of a colorant is prepared in an ink vehicle having a colorant such as a yellow dye (e.g., Y104). The ink vehicle includes about 10% DEG, about 1.5% Triton X-100, and about 0.2% Trizma, and the pH of the ink composition is adjusted to between about 8 and about 8.5. In this embodiment, the ink additive is 1,3-benzene-disulfonic acid or anthraquinone-2-sulfonic acid present in a concentration of about 5%. Two ink compositions each having one of the two additives and a control are printed on a medium (e.g., EPGPP). Curves representing the hue shift for the ink compositions are shown in FIG. 16.

### Example XXIII

In a further embodiment, an ink composition including an ink additive for controlling color of a colorant is prepared in an ink vehicle having a colorant such as a yellow dye (e.g., Y104). The ink vehicle includes about 10% DEG, about 1.5% Triton X-100, and about 0.2% Trizma, and the pH of the ink composition is adjusted to between about 8 and about 8.5. In this embodiment, the ink additive is sodium acetate or sodium dihydrogen phosphate present in a concentration of about 5%. Two ink compositions each having one of the two additives and a control are printed on a medium (e.g., EPGPP).

### Example XXIV

In yet a further embodiment, an ink composition including an ink additive for controlling color of a colorant is prepared in an ink vehicle having a colorant such as a yellow dye (e.g., Y104). The ink vehicle includes about 10% DEG, about 1.5% Triton X-100, and about 0.2% Trizma, and the pH of the ink composition is adjusted to between about 8 and about 8.5. In this embodiment, the ink additive is sodium acetate or sodium dihydrogen phosphate present in a concentration of about 5%. Two ink compositions each having one of the two additives and a control are printed on a medium (e.g., HPPGPP). Curves representing the hue shift values for the ink compositions are shown in FIG. 17.

### Example XXV

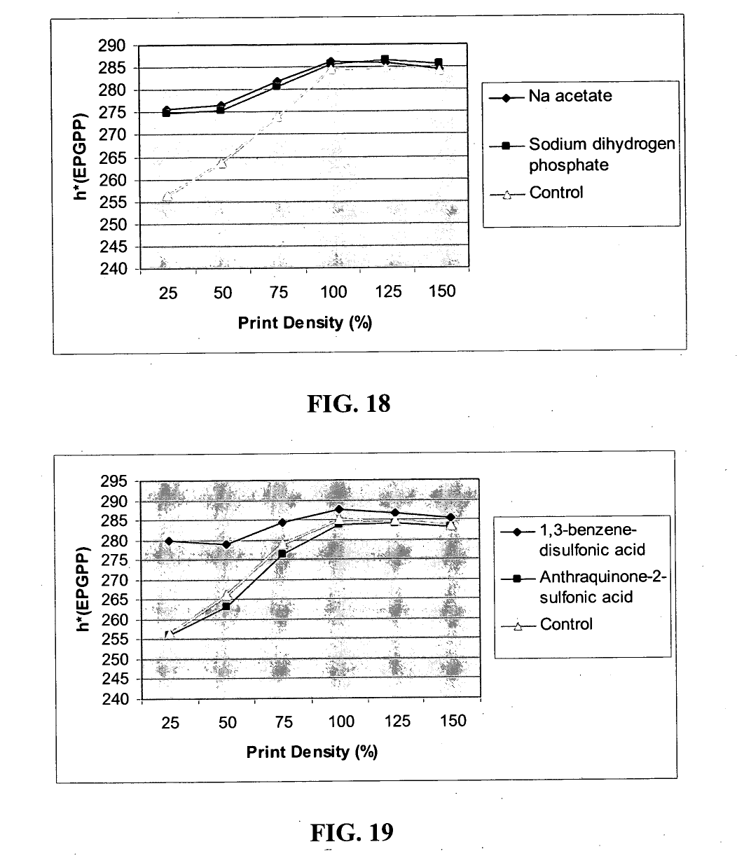

In another embodiment, an ink composition including an ink additive for controlling color of a colorant is prepared in an ink vehicle having a colorant such as a black dye (e.g., Projet K820). The ink vehicle includes about 10% DEG, about 1.5% Triton X-100, and about 0.2% Trizma, and the pH of the ink composition is adjusted to between about 8 and about 8.5. In this embodiment, the ink additive is sodium acetate or sodium dihydrogen phosphate present in a concentration of about 5%. Two ink compositions each having one of the two additives and a control are printed on a medium (e.g., EPGPP). Curves representing the hue shift values for the ink compositions are shown in FIG. 18.

### Example XXVI

In yet another embodiment, an ink composition including an ink additive for controlling color of a colorant is prepared in an ink vehicle having a colorant such as a black dye (e.g., Projet K820). The ink vehicle includes about 10% DEG, about 1.5% Triton X-100, and about 0.2% Trizma, and the pH of the ink composition is adjusted to between about 8 and about 8.5. In this embodiment, the ink additive is 1,3-benzenedisulfonic acid or anthraquinone-2-sulfonic acid present in a concentration of about 5%. In this embodiment, the anthraquinone may have had a solubility problem. Ink compositions having the two additives and a control are printed on a medium (e.g., EPGPP), wherein curves representing the hue shift for the ink compositions are shown in FIG. 19.

### Example XXVII

In an additional embodiment, an ink composition including an ink additive for controlling color of a colorant is prepared in an ink vehicle having a colorant such as DB199, a cyan dye. The ink vehicle includes about 10% DEG, 1.5% Triton X-100, and about 0.2% Trizma, and the pH of the ink composition is adjusted to between about 8 and 8.5. In this embodiment, the ink additive is sodium benzoate or 1-hydroxy-2-naphthoic acid present in a concentration of about 5%. Two ink compositions each having one of the two additives and a control composition are printed on a medium (e.g., EPGPP).

### Example XXVIII

In yet another embodiment, an ink composition including an ink additive for controlling color of a colorant is prepared in an ink vehicle having a colorant such as a cyan dye (e.g., DB199). The ink vehicle includes about 10% DEG, about 1.5% Triton X-100, and about 0.2% Trizma, and the pH of the ink composition is adjusted to between about 8 and about 8.5. In this embodiment, the ink additive is sodium benzoate or 1-hydroxy-2-naphthoic acid present in a concentration of about 5%. Two ink compositions each having one of the two additives and a control composition are printed on a medium (e.g., HPPGPP).

### Example XXIX

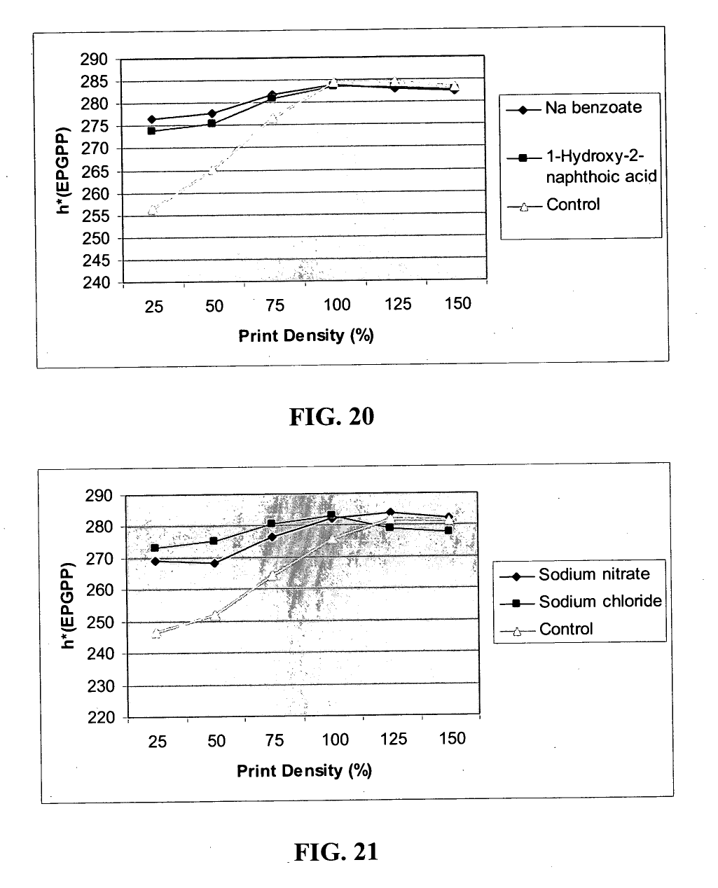

In yet a further embodiment, an ink composition including an ink additive for controlling color of a colorant is prepared in an ink vehicle having a colorant such as a black dye (Projet K820). The ink vehicle includes about 10% DEG, about 1.5% Triton X-100, and about 0.2% Trizma, and the pH of the ink composition is adjusted to between about 8 and about 8.5. In this embodiment, the ink additive is sodium benzoate or 1-hydroxy-2-naphthoic acid present in a concentration of about 5%. Two ink compositions each having one of the two additives and a control are printed on a medium (e.g., EPGPP). Curves representing the hue shift values for the ink compositions are shown in FIG. 20.

### Example XXX

In yet a further embodiment, an ink composition including an ink additive for controlling color of a colorant is prepared in an ink vehicle having a colorant such as a black dye (Projet K820). The ink vehicle includes about 10% DEG, about 1.5% Triton X-100, and about 0.2% Trizma, and the pH of the ink composition is adjusted to between about 8 and about 8.5. In this embodiment, the ink additive is sodium nitrate or sodium chloride present in a concentration of about 5%. Two ink compositions each having one of the two additives and a control are printed on a medium (e.g., HPPGPP).

### Example XXXI

In an additional embodiment, an ink composition including an ink additive for controlling color of a colorant is prepared in an ink vehicle having a colorant such as a black dye (Projet K820). The ink vehicle includes about 10% DEG, about 1.5% Triton X-100, and about 0.2% Trizma, and the pH of the ink composition is adjusted to between about 8 and about 8.5. In this embodiment, the ink additive is sodium nitrate or sodium chloride present in a concentration of about 5%. Two ink compositions each having one of the two additives and a control are printed on a medium (e.g., EPGPP). Curves representing the hue shift values for the ink compositions are shown in FIG. 21.

### Example XXXII

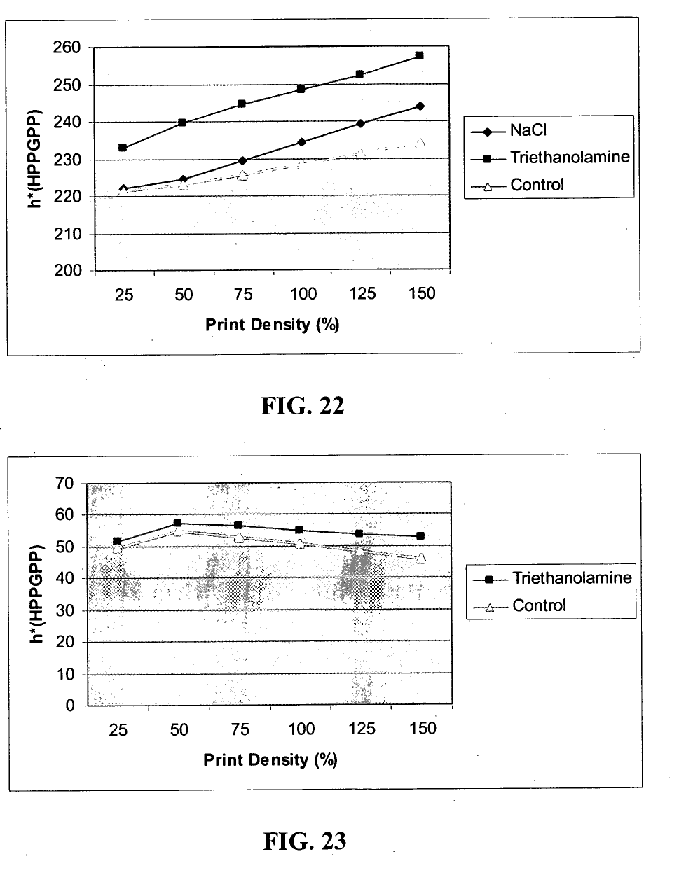

In still another embodiment, an ink composition including an ink additive for controlling color of a colorant is prepared in an ink vehicle having a colorant such as a cyan dye (DB199). The ink vehicle includes about 10% DEG, about 1.5% Triton X-100, and about 0.2% Trizma, and the pH of the ink composition is adjusted to between about 8 and about 8.5. In this embodiment, the ink additive is sodium chloride or triethanolamine present in a concentration of about 3%. Ink compositions having the two additives and a control are printed on a medium (e.g., HPPGPP), wherein curves representing the hue shift values for the ink compositions are shown in FIG. 22.

### Example XXXIII

In another embodiment, an ink composition including an ink additive for controlling color of a colorant is prepared in an ink vehicle having a colorant such as DB199, a cyan dye. The ink vehicle includes about 10% DEG, 1.5% Triton X-100, and about 0.2% Trizma, and the pH of the ink composition is adjusted to between about 8 and 8.5. In this embodiment, the ink additive is sodium chloride or triethanolamine present in a concentration of about 5%. Two ink compositions each having one of the two additives and a control are printed on a medium (e.g., HPPGPP). Curves representing the hue shift values for the ink compositions are shown in FIG. 23.

### Example XXXIV

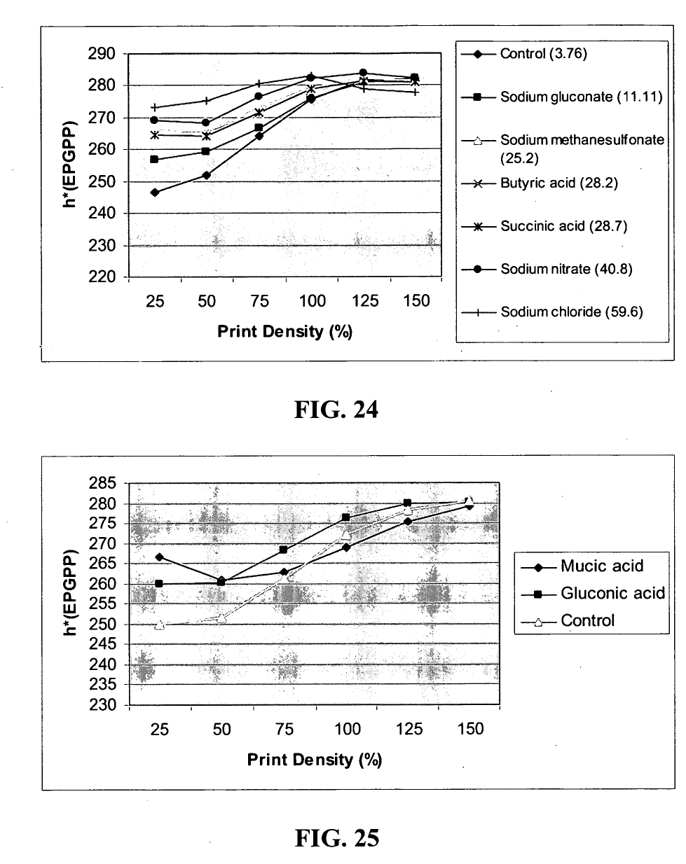

In a further embodiment, an ink composition including an ink additive for controlling color of a colorant is prepared in an ink vehicle having a colorant such as a black dye (Projet K820). The ink vehicle includes about 10% DEG, about 1.5% Triton X-100, and about 0.2% Trizma, and the pH of the ink composition is adjusted to between about 8 and about 8.5. In this embodiment, the ink additive is sodium gluconate, methanesulfonate, butyric acid, succinic acid, sodium nitrate or sodium chloride present in a concentration of about 5%. Ink compositions each having one of the aforementioned additives and a control composition are printed on a medium. Curves representing the hue shift values for the ink compositions are shown in FIG. 24.

FIG. 24 also indicates that the color changes or the ability of the ink additives to control color are in accordance with conductivity, which is shown in parentheses. For instance, conductivities in mS/cm for each of the ink additives in the ink compositions is as follows control, 3.76; sodium gluconate, 11.11; methanesulfonate, 28.2; succinic acid, 28.7; sodium nitrate, 40.8; and sodium chloride, 59.6. A conductivity increase of about 1.2 mS/cm of the ink composition correlates to a visible change in the color.

### Example XXXV

In yet an additional embodiment, an ink composition including an ink additive for controlling color of a colorant is prepared in an ink vehicle having a colorant such as a black dye (Projet K820). The ink vehicle includes about 20% 2-pyrrolidone, about 1.5% Triton X-100, and about 0.2% Trizma, and the pH of the ink composition is adjusted to between about 8 and about 8.5. In this embodiment, the ink additive is sodium mucate or sodium gluconate present in a concentration of about 5%. Two ink compositions each having one of the two additives and a control composition are printed on a medium (e.g., EPGPP). Curves representing the hue shift values for the ink compositions are shown in FIG. 25.

Although the present invention has been shown and described with respect to various exemplary embodiments and examples, various additions, deletions, and modifications that are obvious to a person of ordinary skill in the art to which the invention pertains, even if not shown or specifically described herein, are deemed to lie within the scope of the invention as encompassed by the following claims. Further, features of elements of different embodiments or examples may be employed in combination.

What is claimed is:

1. An ink composition, comprising:
an ink vehicle;
a colorant; and
an additive for controlling color produced by the colorant on a print medium.

2. The ink composition of claim 1, wherein the colorant is one or more dyes.

3. The ink composition of claim 1, wherein the additive for controlling the color produced by the colorant on the print medium is selected from the group consisting of an amine, an organic salt, an inorganic salt, a compound capable of generating an amine, a compound capable of forming a salt, a monovalent salt and any combination thereof.

4. The ink composition of claim 1, wherein the additive for controlling the color produced by the colorant on the print medium is selected from the group consisting of amines, including aliphatic, aromatic, primary, secondary, tertiary, and amine oxides; a proton sponge (1,8-bis-[dimethylamino]naphthalene); triethanolamine; diethanolamine; trizma buffer; 2,6-dimethylaminopyridine; 3-pyridylcarbinol; N-methyl-1,3-propanediamine; ethylenediaminetetraacetic acid; piperidine; piperazine; pyridine-N-oxide; 1-methyl-2-thioimidazole; imidazo[1,2-a]pyridine; N,N-diethylethylenediamine; glycine; DL-threonine; imidazole; 3-(N-morpholino)-propanesulfonic acid; 6-amino-1-naphthol-3-sulfonic acid; 6-amino-4-hydroxy-2-naphthalene-sulfonic acid; Hexamethylenediaminetetra(methylenephosphonic acid); piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine; isonicotinic acid; piperazine-1,4-bis(2-ethanesulfonic acid; triethylamine; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; succinic acid; butyric acid; sodium methanesulfonate; sodium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

5. The ink composition of claim 1, wherein the additive for controlling the color produced by the ink composition on the print medium is present in the ink composition in an amount of between about 0.1% and about 10%.

6. The ink composition of claim 1, wherein the ink composition has a conductivity change of between about 5 mS/cm and about 60 mS/cm over that of an ink composition without the additive.

7. A process for forming an ink composition, the process comprising:
selecting an ink additive for its ability to control color of a chlorant; and
admixing an ink vehicle with the colorant and the selected ink additive, thus forming an ink composition.

8. The process according to claim 7, wherein the ink additive is selected from the group consisting of an amine, an organic salt, an inorganic salt, a compound capable of generating an amine, a compound capable of forming a salt, a monovalent salt and any combination thereof.

9. The process according to claim 7, wherein the ink additive is selected from the group consisting of amines, including aliphatic, aromatic, primary, secondary, tertiary, and amine oxides; a proton sponge (1,8-bis-[dimethylamino]naphthalene); triethanolamine; diethanolamine; trizma buffer; 2,6-dimethylaminopyridine; 3-pyridylcarbinol; N-methyl-1,3-propanediamine; ethylenediaminetetraacetic acid; piperidine; piperazine; pyridine-N-oxide; 1-methyl-2-thioimidazole; imidazo[1,2-a]pyridine; N,N-diethylethylenediamine; glycine; DL-threonine; imidazole; 3-(N-morpholino)-propanesulfonic acid; 6-amino-1-naphthol-3-sulfonic acid; 6-amino-4-hydroxy-2-naphthalene-sulfonic acid; Hexamethylenediaminetetra(methylenephosphonic acid); piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine; isonicotinic acid; piperazine-1,4-bis(2-ethanesulfonic acid; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; succinic acid; butyric acid; sodium methanesulfonate; sodium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.

10. The process according to claim 7, wherein the ink additive is present in the ink composition in an amount of between about 0.1% and about 10%.

11. The process according to claim 7, wherein the ink composition has a conductivity change of between about 5 mS/cm and about 60 mS/cm over that of an ink composition without the additive.

12. An ink composition produced by the process according to claim 7.

13. An ink-jet printing system, comprising:
a print medium; and
an ink composition configured for printing on the print medium, the ink composition comprising:
an ink vehicle;
a colorant admixed in the ink vehicle; and
an ink additive for controlling the color produced by the colorant on a print medium.

14. The ink-jet printing system of claim 13, wherein the print medium comprises a porous or a swellable medium.

15. The ink-jet printing system of claim 13, wherein the ink additive is selected from the group consisting of an amine, an organic salt, an inorganic salt, a compound capable of generating an amine, a compound capable of forming a salt, a monovalent salt and any combination thereof.

16. The ink-jet printing system of claim 13, wherein the ink additive is present in the ink composition in an amount of between about 0.1% and about 10%.

17. The ink-jet printing system of claim 13, wherein the ink composition has a conductivity change of between about 5 mS/cm and about 60 mS/cm over that of an ink composition without the additive.

18. The ink-jet printing system of claim 13, wherein the ink additive is selected from the group consisting of amines, including aliphatic, aromatic, primary, secondary, tertiary, and amine oxides; a proton sponge (1,8-bis-[dimethylamino]naphthalene); triethanolamine; diethanolamine; trizma buffer; 2,6-dimethylaminopyridine; 3-pyridylcarbinol; N-methyl-1,3-propanediamine; ethylenediaminetetraacetic acid; piperidine; piperazine; pyridine-N-oxide; 1-methyl-2-thioimidazole; imidazo[1,2-a]pyridine; N,N-diethylethylenediamine; glycine; DL-threonine; imidazole; 3-(N-morpholino)-propanesulfonic acid; 6-amino-1-naphthol-3-sulfonic acid; 6-amino-4-hydroxy-2-naphthalene-sulfonic acid; Hexamethylenediaminetetra(methylenephosphonic acid); piperazine-2-carboxylic acid; N-(2-hydroxyethyl)piperazine-N′-(2-ethanesulfonic acid); homopiperazine; 4-piperidineethanol; isonipecotic acid; 1,4-dimethylpiperazine; 4-(2-hydroxyethyl)piperazine-1-propanesulfonic acid; triethylenediamine; isonicotinic acid; piperazine-1,4-bis(2-ethanesulfonic acid; sodium acetate; sodium dihydrogen phosphate; sodium octanoate; cyanoacetic acid; 4,5-dihydroxy-1,3-benzenedisulfonic acid; 2-acetylcyclopentanone; 6-amino-1-naphthol-3-sulfonic acid; 6-amino-4-hydroxy-2-naphthalenesulfonic acid; glucoheptonic acid; lactobionic acid; mucic acid; sodium chloride; succinic acid; butyric acid; sodium methanesulfonate; sodium gluconate; sodium nitrate; 1,3-benzene-disulfonic acid; anthraquinone-2-sulfonic acid; sodium benzoate; 1-hydroxy-2-naphthoic acid; sodium mucate; and any combinations thereof.
